(19) United States
(12) Patent Application Publication
(10) Pub. No.: US 2003/0122881 A1
(43) Pub. Date: Jul. 3, 2003

(54) METHOD OF AND APPARATUS FOR PROCESSING CHARACTERS, AND STORAGE NEDIUM STORING CHARACTER PROCESSING PROGRAM

(76) Inventor: MEGUMI YOSHIDA, KAWASAKI-SHI (JP)

Correspondence Address: FITZPATRICK CELLA HARPER & SCINTO, 30 ROCKEFELLER PLAZA, NEW YORK, NY, 10112, US

(21) Appl. No.: 09/422,565

(22) Filed: Oct. 21, 1999

(30) Foreign Application Priority Data
Oct. 23, 1998 (JP) 302206/1998

(51) Int. Cl. G09G 5/00

(52) U.S. Cl. 345/862

(57) ABSTRACT

A plurality of character strings corresponding to words or the like are displayed in the form of an at-a-glance list. A user can select a desired character string from among the displayed character strings, so that the selected character string is automatically input to fill in a character string display box. A new character string can be added to the list of registered character strings. Functions are also available for editorial operations, such as addition or deletion on the registered character strings. The user is relieved of the burden of inputting characters of the character string one by one, thus offering improvement in efficiency of input work, particularly when the word constituted by the character string is often used by the user.

### BACKGROUND OF THE INVENTION

1. Field of the Invention

The present invention relates to a method of and an apparatus for processing characters, as well as to a storage medium storing a character processing program, which permit easy input of characters. More particularly, the present invention is concerned with a character processing method and a character processing apparatus, as well as a storage medium, which, by means of a displayed virtual keyboard, enables a user to register and edit character strings such as words, phrases and short sentences that are frequently used by the user. Still more particularly, the present invention pertains to character processing method and apparatus, as well as to a storage medium, which enable the user to input a registered character string by a single touch on a virtual keyboard.

2. Description of the Related Art

Conventionally, characters are input by means of keys on a keyboard, such that a touch on a single key enters a character that has been registered in association with the key.

Thus, the user when inputting a word, phrase or a short sentence is obliged to press in a one-by-one fashion all the keys corresponding to characters that constitute such a word, phrase or the shirt sentence, even when such a word, phrase or short sentence is-used frequently by the user.

### SUMMARY OF THE INVENTION

Accordingly, it is an object of the present invention to provide a character processing method, a character processing apparatus and a storage medium that obviates the above-described problems of the known art.

According to one aspect of the present invention, there is provided a character processing method in which a plurality of registered character strings are displayed in an at-a-glance manner, so as to enable a desired character string to be selected and then displayed at a position on the display screen designated by a cursor. The invention also provides a character processing apparatus for carrying out the character processing method and a storage medium storing a program that implements the character processing method.

Preferably, the selection of the character string is achieved by an instruction which designates a position in a region in which the character string to be selected is displayed.

Preferably, the at-a-glance display of the character strings is performed on a soft keyboard display screen.

Preferably, the at-a-glance display of the character strings is performed in accordance with an instruction given through the soft keyboard display screen.

Preferably, the at-a-glance display of the character strings is displayed in place of the soft keyboard display screen, in response to the instruction given through the soft keyboard.

Preferably, the plurality of character strings have been registered through an operation performed by the user.

Preferably, the selected character string is input to a display screen which is displayed to enable entry of a character string to be added to image information.

Preferably, the at-a-glance display of the registered character strings is performed on a display screen which is displayed to enable entry of a character string to be added to image information.

Preferably, the selected character string is input to a display screen which is displayed to enable entry of a character string designating a destination to which information is to be sent.

Preferably, the at-a-glance display of the registered character strings is performed on a display screen which is displayed to enable entry of a character string designating a destination to which information is to be sent.

The at-a-glance display of the registered character strings may be implemented on an operation panel of a copying machine.

The selected character string may be output by means of a printer.

Preferably, the instruction is given through a touch panel.

The instruction may also be given through a digitizer.

The instruction may also be given through a coordinate input device.

The present invention also provides a character processing method, as well as a character processing apparatus and a storage medium, wherein the method comprises the steps of: performing an at-a-glance display of a plurality of registered character strings; allowing selection of a desired character string out of the displayed character strings; receiving an editorial instruction indicating an editorial work to be effected on the selected character string; effecting the editorial work in accordance with the editorial instruction on the selected character string; and updating the registered character strings in accordance with the result of the editorial work.

The editorial instruction may be to add a character.

The editorial instruction may be to delete a character.

Preferably, the editorial instruction is input through a displayed soft keyboard.

The character processing apparatus for carrying out the above-described character processing method may have updating means for updating the registered character strings. The update of the registered character strings may be to add a new character string or to delete a character string.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a schematic illustration of a network system incorporating the present invention;

FIG. 2 is a block diagram of an image processing apparatus incorporating the present invention;

FIG. 3 is a diagrammatic illustration of the image processing apparatus;

FIG. 4 is an illustration of an operating section of the image processing apparatus;

FIG. 5 is an illustration of a “SEND” main display screen;

FIG. 6 is an e-mail address input display screen;

FIG. 7 is an illustration of the e-mail address display screen, with a character string input therein;

FIG. 8 is an illustration of the “SEND” main display screen with the-destination address designated thereon;

FIG. 9 is an illustration of a setting display screen for a “SEND” function;

FIG. 10 is an illustration of transition of the display screen in the course of execution of a function for invoking a word registered in a keyboard;

FIG. 11 is an illustration of transition of the display screen in the course of execution of functions for correcting and deleting a word registered in a keyboard;

FIG. 12 is an illustration of transition of the display screen in the course of execution of a function for registering a new word in the keyboard;

FIG. 13 is an illustration of a keyboard display screen;

FIG. 14 is an illustration of a word registration list display screen;

FIG. 15 is an illustration of the word registration list display screen with a selected word designated thereon;

FIG. 16 is an illustration of the keyboard display screen showing an entered character string;

FIG. 17 is an illustration of a word registration keyboard display screen;

FIG. 18 is an illustration of the word registration keyboard display screen on which a word is being corrected;

FIG. 19 is an illustration of a word registration list display screen showing a corrected word registered thereon;

FIG. 20 is an illustration of the word registration display screen with a designated word deleted therefrom;

FIG. 21 is an illustration of the word registration keyboard display screen displayed for the purpose of enabling registration of a new word;

FIG. 22 is an illustration of the word registration keyboard display screen, in which a character string to be newly registered has been entered;

FIG. 23 is an illustration of the word registration list display screen in which a new word in the form of a character string has been registered;

FIG. 24 is an illustration of the keyboard display screen which displays a selected word in the form of an input character string; and

FIG. 25 is a flowchart showing a process which implements the character processing in accordance with the present invention.

### DESCRIPTION OF THE PREFERRED EMBODIMENT

The preferred embodiment of the present invention will be described with reference to the accompanying drawings.

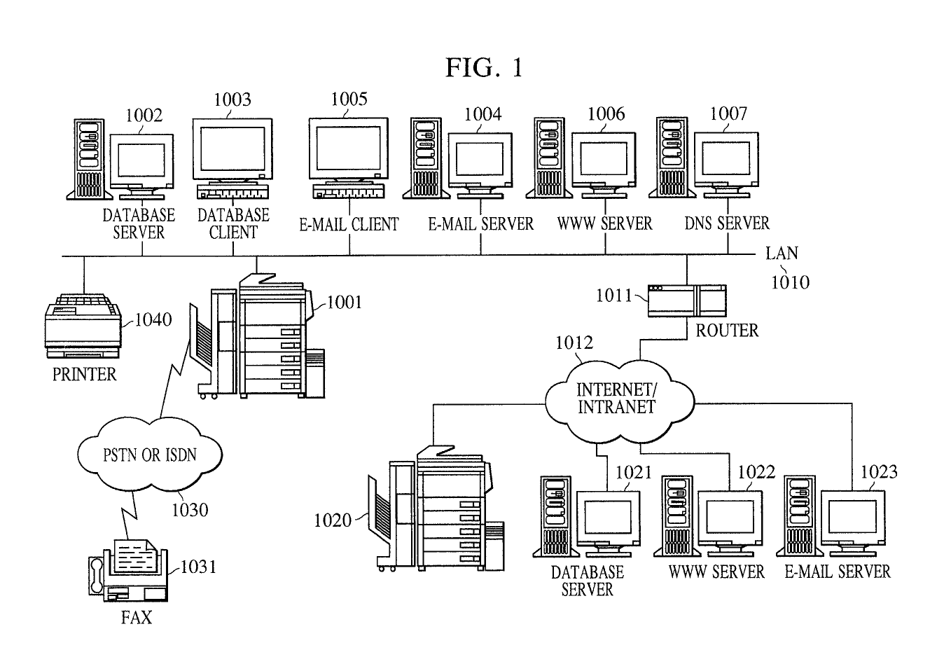

FIG. 1 shows a network system which incorporates the present invention and which has various components connected in a manner which will now be described.

An image processing apparatus 1001 includes a scanner and a printer, both of which will be described below. The image processing apparatus 1001 has various functions such as delivery of an image read by the scanner to a local area network (referred to as a “LAN”, hereinafter) denoted by 1010, printing by the printer of an image received from the LAN 1010, and so forth. The image processing apparatus 1001 is also capable of sending, by means of a facsimile transmission module, an image read by the scanner to a public communication network such as a PSTN or an ISDN 1030, and printing, by means of the printer, of an image received through such a public communication network.

A database server 1002 administrates a database constituted by binary images and multilevel images read by the image processing apparatus 1001. A database client 1003 of the database server 1002 inspects and retrieves image data stored in the database server 1002.

An e-mail server 1004 can receive an image read by the image processing apparatus 1001, as an appendix to an e-mail.

An e-mail client 1005 is an ordinary general-purpose computer terminal which is capable of conducting ordinary email processing such as receipt, inspection and sending of e-mails.

A WWW server 1006 can deliver an HTML document to the LAN, so that the image processing apparatus 1001 can print the HTML document received through the WWW server 1006.

A router 1007 serves to connect the LAN 1010 to Internet/intranet 1012. To the Internet/intranet are connected an image processing apparatus 1020, database server 1021, WWW server 1022 and an e-mail server 1023 which are the same as the image processing apparatus 1001, database server 10002, WWW server 1006 and the e-mail server 1004.

The image processing apparatus 1001 can communicate with a facsimile unit 1031 through the PSTN or ISDN 1030 to exchange data therebetween. A separate printer 1040 also is connected to the LAN 1010 and is capable of printing an image read by the image processing apparatus 1001.

A detailed description will now be given of the structure and operation of the image processing apparatus 1001.

(1) Overall configuration

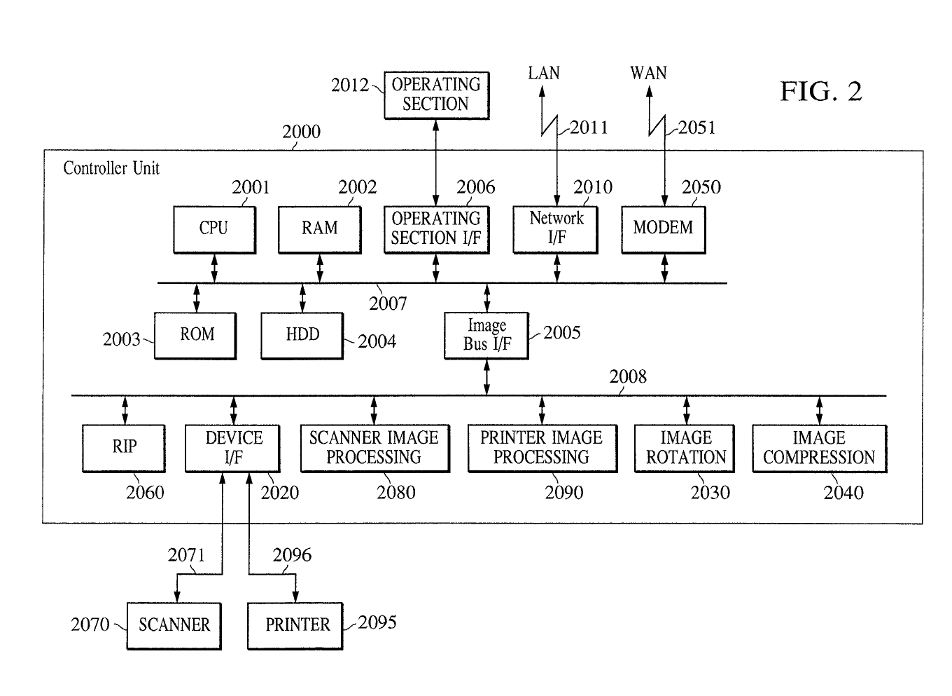

FIG. 2 is a block diagram showing the configuration of the entire image processing apparatus 1001.

A controller unit 2000 is connected to the aforesaid scanner which is denoted by 2070 and which serves as an image input device for reading an image on an original, and connected also to the aforesaid printer which is denoted by 2095 and which serves as an image output device for visibly recording and outputting an image. The controller unit 2000 is connected to a LAN 2011 (LAN 1010) and a public communication network (WAN) 2051, e.g., the PSTN or ISDN 1030. Thus, the controller unit 2000 also serves as a controller for inputting and outputting image information and device information.

A CPU 20001 performs an overall control of a binary image processing unit by executing various kinds of processing in accordance with programs stored in a RAM 2002 and a ROM 2003.

The RAM 2002 is a system work memory which provides a work area for the operation of the CPU 2002. The RAM 2003 also serves as an image memory that temporarily stores image data. The RAM 2002 has data storage areas such as a keyboard display character string memory (memory A-1), word registration keyboard character string memory (memory A-2), a word registration list address (memory B), and so forth which will be described later. The RAM 2002 stores a registered word list which contains registered words and is copied from an HDD (hard disk drive) 2004, and performs as desired writing to and reading from the registered word list in the HDD 2004. This ensures that that the content of the registered word list in the RAM 2002 always coincides with that in the HDD 2004. Words that are expected to be used widely and frequently may be registered beforehand in the registered word list, in advance of the shipping of the product. Such pre-installed words are easily editable by the user through an editorial processing which will be described later.

The ROM 2003 is a boot ROM which stores a boot program of the image processing apparatus.

The HDD 2004 stores a system software program, image data, the registered word list, etc. It is to be understood that the content of the registered word list will now disappear even after the power supply is turned off, because the list is stored in the HDD 2004. Control programs for implementing various kinds of control executed in the image processing apparatus, other than those stored in the ROM 2003 and the RAM 2002, may be acquired by being down-loaded from a terminal connected to the LAN 2011 or the WAN 2051, or from a demountable external storage medium such as a CDROM, MO or the like. These externally-available programs also may be directly used for the controlling purposes without being down-loaded.

An operating section I/F 2006 serves as an interface between the operating section (UI) 2012 and other sections or components. Image data to be displayed on the operating section 2012 is delivered to the operating section 2012 through the operating section I/F 2006. Similarly, information input by the user is delivered to the CPU 2001 through the operating section I/F 2006.

A network I/F 2010 connects the image processing apparatus to the LAN 2011 which has a plurality of terminals, thus enabling exchange of information between the image processing apparatus and the LAN 2011. A MODEM 2050 interconnects the image processing apparatus and the public communication network 2051 to enable exchange of information therebetween.

The devices described heretofore are arranged on a system BUS 2007.

An image BUS I/F 2005 is a bridge BUS that interconnects the system BUS 2007 and an image BUS 2008 which performs high-speed transfer of image data while effecting transformation of data architecture. The image BUS 2008 may have a PCI BUS or an IEEE 1394.

The following devices are arranged on the image BUS 2008.

A raster image processor (RIP) 2060 develops a PDL code into a bit map image.

A device I/F 2020 connects the scanner 2070 and the printer 2095 serving as the image input/output devices to the controller 2000, and performs synchronous/asynchronous transformation of the image data.

A scanner image processing unit 2080 enables correction, processing and edition of input image data.

A printer image processing unit 2090 performs operations such-as correction of the printer parameters, conversion of image resolution, and so forth, on the image data to be printed out.

An image rotation unit 2030 performs rotation of the image data.

An image compression unit 2040 performs compression/expansion processings for image data, such as JPEG for multilevel images and JBIG, MMR, MH and so forth on binary image data.

A printer 2095 prints images and character strings processed by the image processing apparatus, and may be a laser printer or an ink jet printer.

(2) Image input/output section

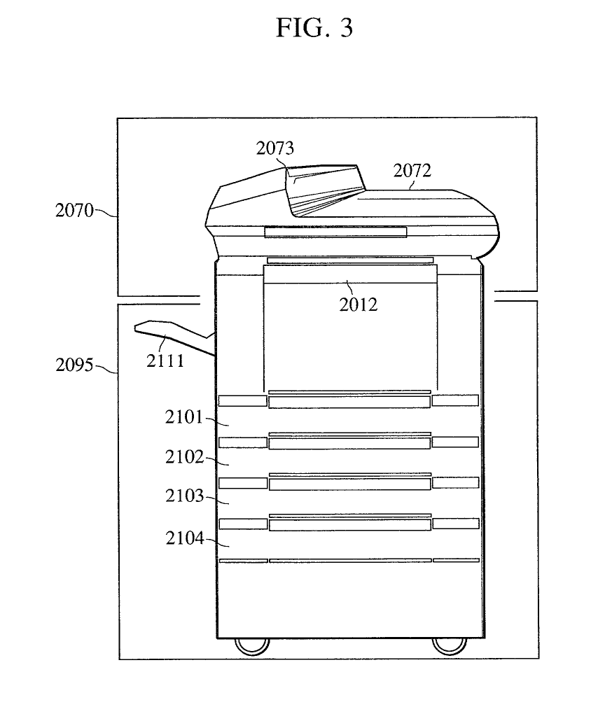

FIG. 3 diagrammatically shows the image input/output devices. As in other figures of the drawings, the same reference numerals as those mentioned heretofore denote the same parts or components as described hereinbefore.

The scanner 2070 serving as the image input device illuminates an image on an original and scans the image with a CCD line sensor (not shown) thereby reading the image. The scanner 2070 then converts the read image into electrical signals in the form of raster image data 2071. A plurality of sheets of original may be set on a tray 2073 of the original feeder 2072. In response to a read start instruction given by the user through the operating section 2012, the controller CPU 2001 gives a reading instruction (2071) to the scanner 2070, so that the feeder 2072 feeds the sheets to be read in a one-by-one fashion.

The printer 2095 as the image output device is a unit that converts the electrical raster image data into a visible image on a sheet of paper. The printer may be of any known type, such as an electrophotographic printer relying on a photosensitive drum or a photosensitive belt, an ink jet printer having an array of tiny nozzle holes which eject ink droplets to directly print images on paper sheets, and so forth. The printing operation is started in response to an instruction given by the controller CPU 2001. The printer 2095 has a plurality of sheet feed bins adapted to accommodate paper sheets of different sizes or orientations. A plurality of sheet cassettes 2101, 2102, 2103 and 2104 are used corresponding to these sheet feed bins. A sheet eject tray 2111 receives paper sheets on which images have been printed by the printer.

(3) Operating section

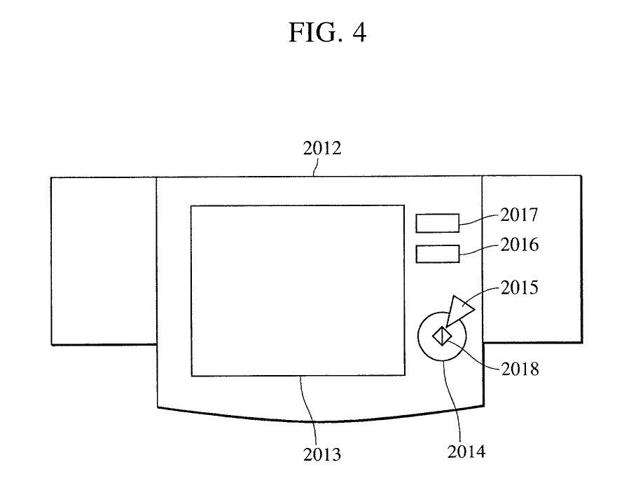

FIG. 4 schematically shows the configuration of the operating section 2012.

An LCD display portion 2013 has an LCD (liquid crystal display unit) having a touch panel sheet pasted thereon. The LCD display portion 2013 displays an operation display screen which enables the user to operate the image processing apparatus and, when one of the soft keys displayed thereon is pressed by the user, transmits the coordinate information concerning the position of the soft key to the controller CPU 2001. Upon receipt of such coordinate information, the controller CPU 2001 understands the intention of the user and executes a processing corresponding to the pressed key, and switches the display screen as required. The use in this embodiment of the LCD with the touch panel as the operating section is not to exclude other arrangements. For instance, the operating section may be implemented by other type of display device, such as a CRT, combined with other coordinate input means, such as a mouse or a pen.

A start key 2014 is used, for example, for the purpose of triggering reading of an original image. A pair of LEDs 2018 of two different colors, green and red, are disposed on the central region of the start key 2014, in order to indicate whether the start key 2014 is ready for use. A stop key 2015 when pressed stops the operation of the image processing apparatus. An ID key 2016 is used to enable the user to input an ID of the user. A reset key 2017 is used to initialize the conditions which have been set through the operating section 2012. All these keys 2014 to 2017 are hard keys.

A detailed description will be given of the display screens which are to be displayed on the display portion 2013 of the operating section 2012, as well as of various input and editorial functions available on such display screens, with reference to figures showing the display screens and a process flowchart.

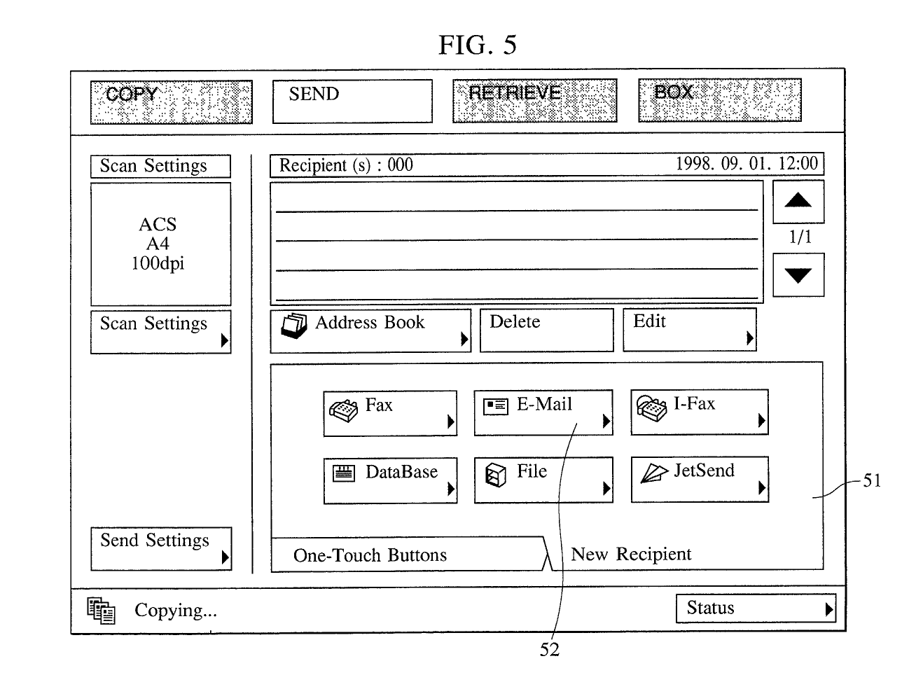

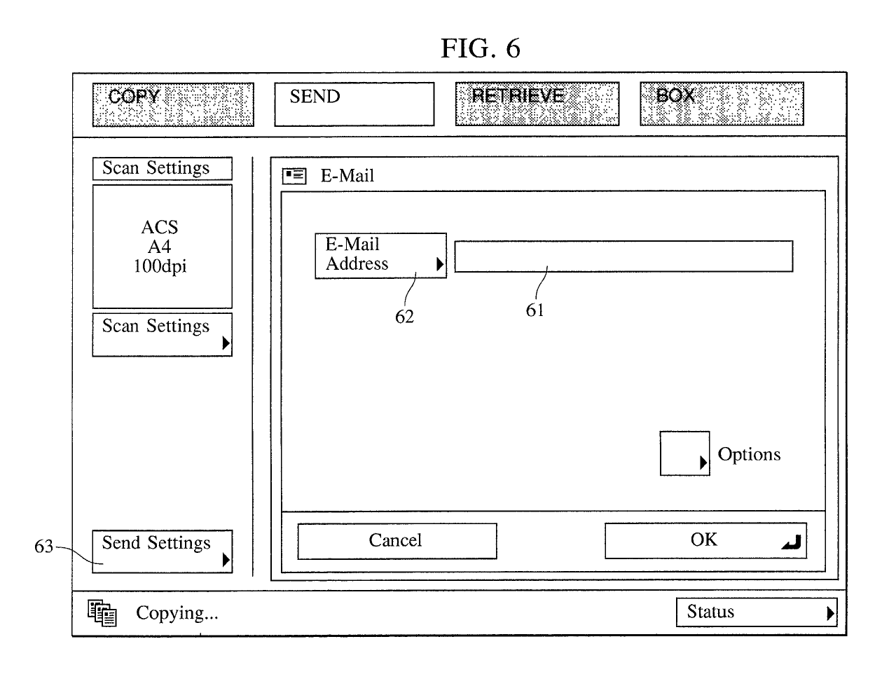

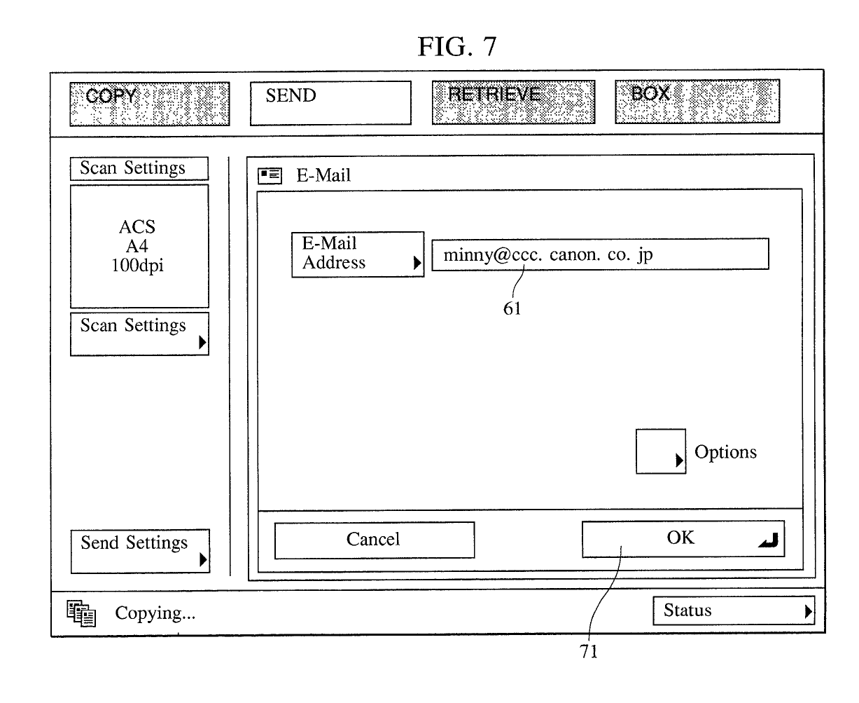

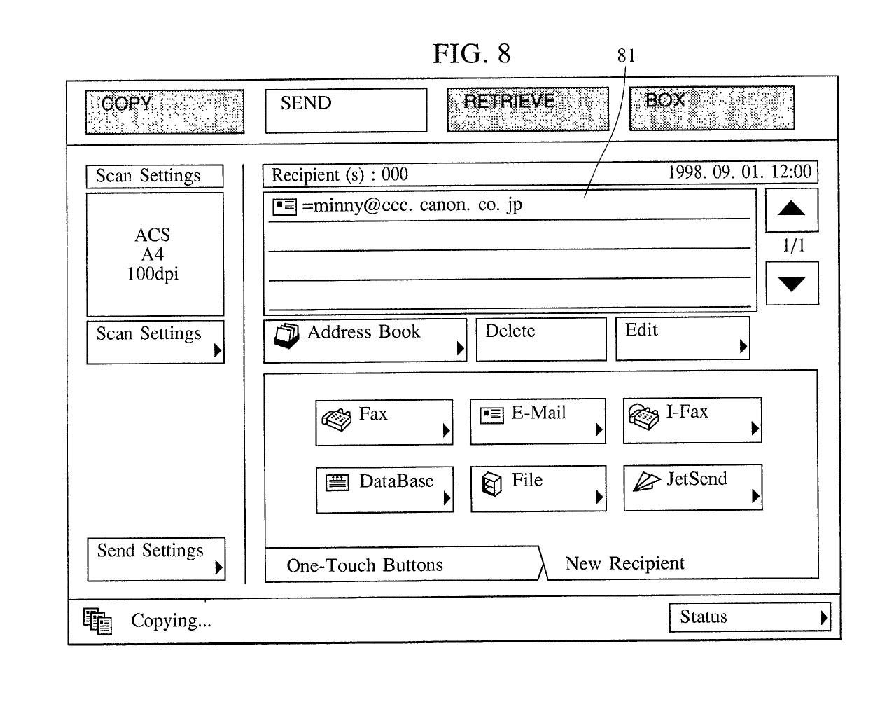

FIG. 5 illustrates a “SEND” main display screen which commands all the aforementioned sending functions used for sending images to be processed by the image processing apparatus. These sending functions include the facsimile function, e-main function, internet facsimile function (I-Fax), registration of data in databases, registration in files, “Jet Send” function, and so on. The user can designate or add a destination to which the image is to be sent, by pressing a key in the panel 51 corresponding to the desired sending function followed by entry of information requested by the sending function. For instance, when an email button 52 is pressed, a destination address input display screen (see FIG. 6) appears on the LCD display portion 2013, including an e-mail address input box 61 for accepting entry of an e-mail address. In response to a subsequent pressing of an e-mail address button 62, a keyboard display screen appears on the display. A character string input by the user through the keyboard display screen fills in the e-mail address input box (see FIG. 7). In response to a subsequent pressing of an “OK” button 71, the controller CPU 2001 determines that the entry of the destination e-mail address has been completed, and resets the display to the “SEND” main display screen, in which the input e-mail address is displayed in a receiver list box 81 together with an icon which indicates that the input address is an e-mail address (see FIG. 8). The address thus designated is stored as the destination.

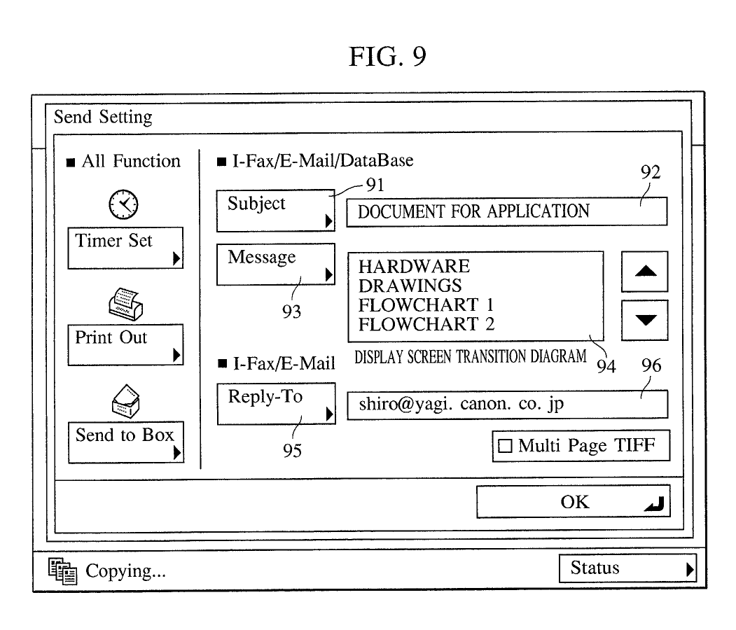

FIG. 9 shows, by way of example, a setting display screen which enables the user to set conditions of the “SEND” function. This display screen appears when a “Send Settings” key 63 on the “SEND” main display screen is pressed. The setting screen includes a subject input box 92 to be filled by a character string which indicates the subject of an image to be sent by means of the I-Fax function, e-mail function or the database function and which is to be attached to the image to be sent. The setting screen also includes a message input box 94 to be filled by a character string which indicates a massage to be attached to the image to be sent by means of the I-Fax function, email function or the database function. The setting screen also includes a reply address input box 96 which is to be filled by a character string indicative of the address to which the reply to an image sent by the I-Fax or e-mail function is to be directed. Entry of the character string to these boxes 92, 94 and 96 is performed through a keyboard display screen which appears in response to pressing of one of a subject input instruction button “Subject” 91, a message input instruction button “Message” 93 and a reply destination input instruction button (Reply-To) 95.

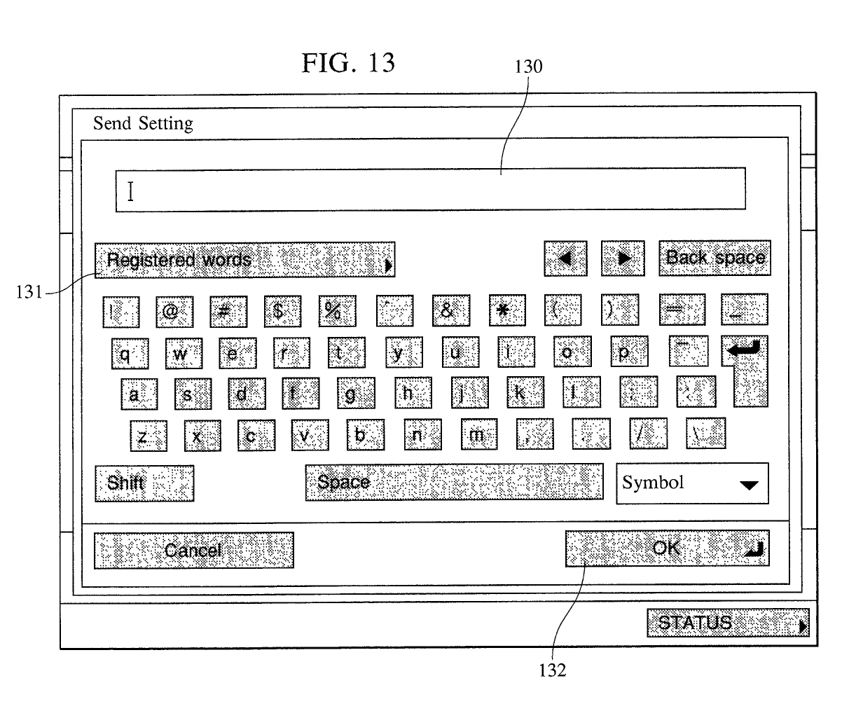

FIG. 13 shows the keyboard display screen which appears in response to the pressing of one of the above-mentioned buttons and which enables entry of character strings. A description will now be given of the details of various kinds of processing which start from this keyboard display screen. The keyboard display screen permits not only an ordinary character-by-character entry through pressing of each character key but also a selection and one-touch entry of one of registered words each of which consists of a character string having a plurality of characters. Words that have been registered on the soft keyboard can conveniently be used in any occasion in which the soft keyboard is displayed for the purpose of enabling entry of a character string to fill in any of the character string input boxes. It is not necessary to assign a button to each of the registered words, so that the key display area can be saved advantageously. The user can effect correction, addition and deletion of the registered words as necessary, through the processings describe below.

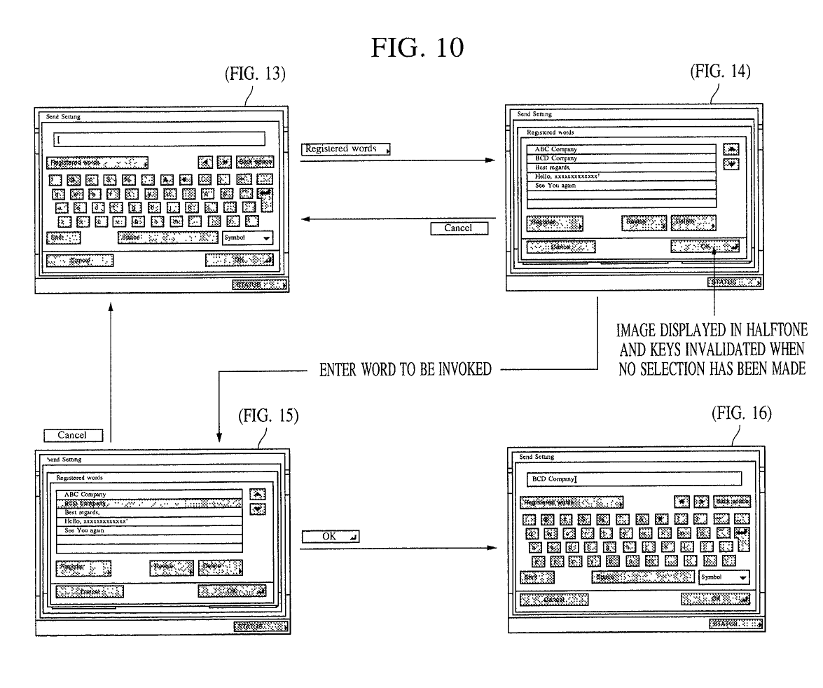

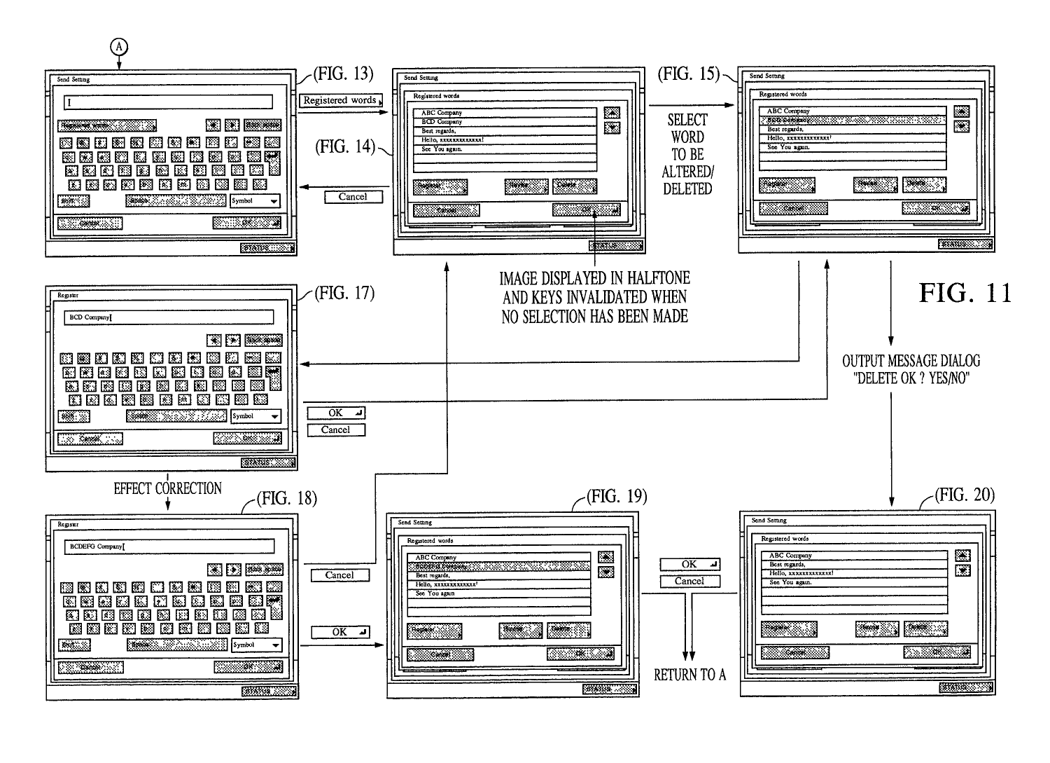

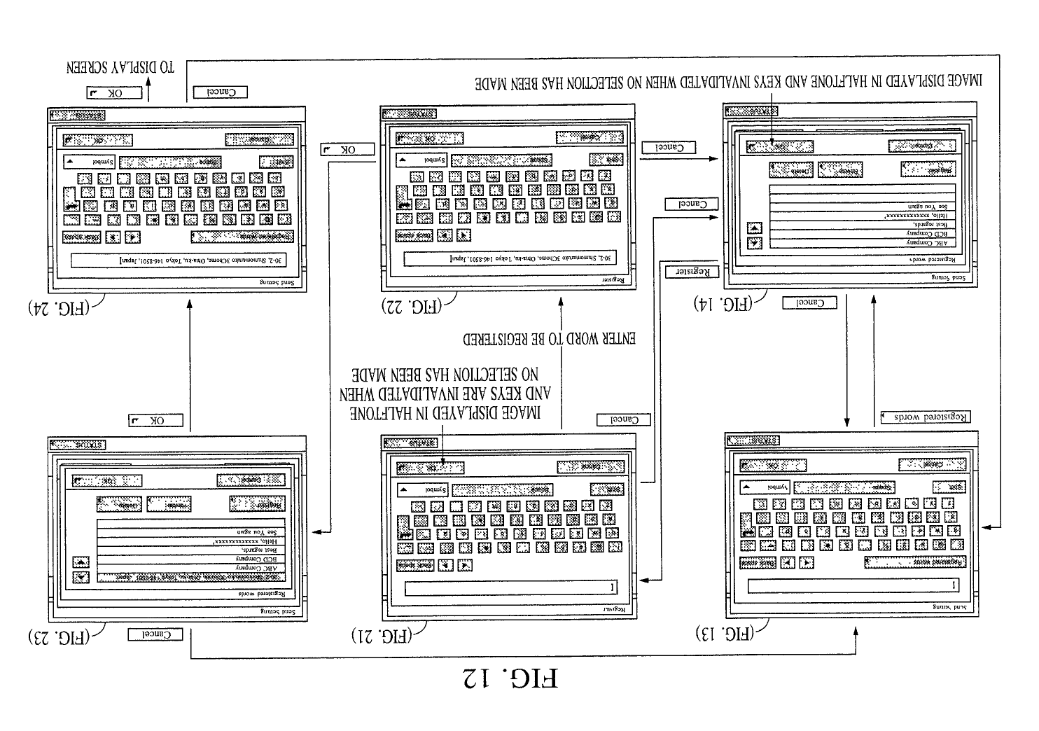

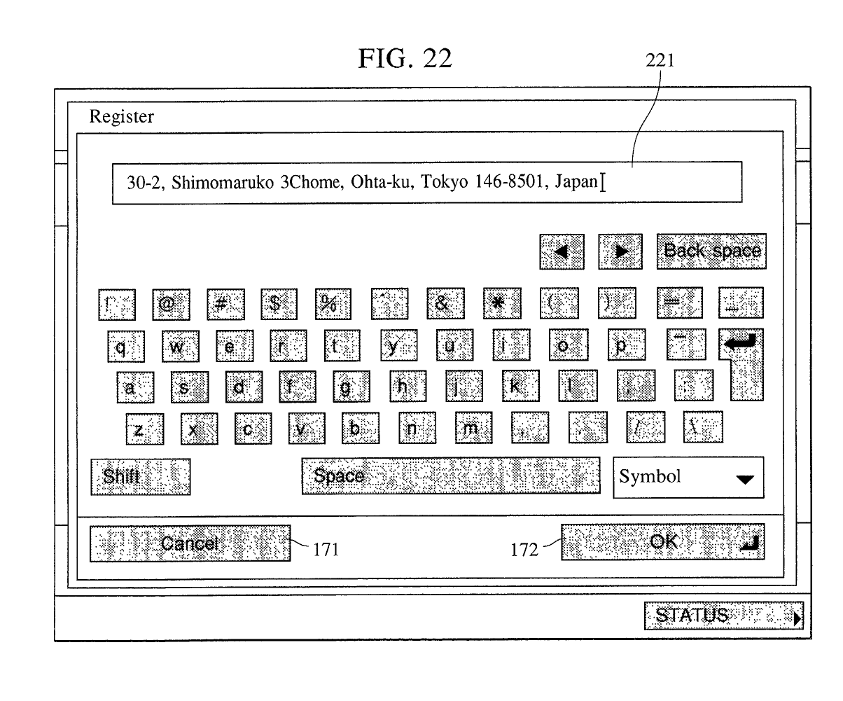

FIG. 10 is a display screen transition diagram showing the transition of the display screen which is caused when a function for invoking a word registered on the soft keyboard is executed. FIG. 11 is a display screen transition chart showing the transition of the display screen which is caused when a function for correcting or deleting a word registered on the soft keyboard is executed. FIG. 12 is a display screen transition chart showing the transition of the display screen which is caused when a function for registering a new word on the soft keyboard is executed. Each of the display screen transition charts shown in FIGS. 10, 11 and 12 contains a plurality of display screens and shows how the contents of the display are changed in response to pressing of a key or an entry effected on each display screen. Each state of transition, i.e., change from one to another display screen, is indicated by an arrow. The content of the operation which has triggered such a change of the display content is shown in the vicinity of each arrow. The display screens shown in the display screen transition charts are shown in a greater scale in FIGS. 13 to 24, respectively. In each display screen transition chart, each of the display screens shown in FIGS. 13 to 24 is identified by the Figure Number shown in a parenthesis.

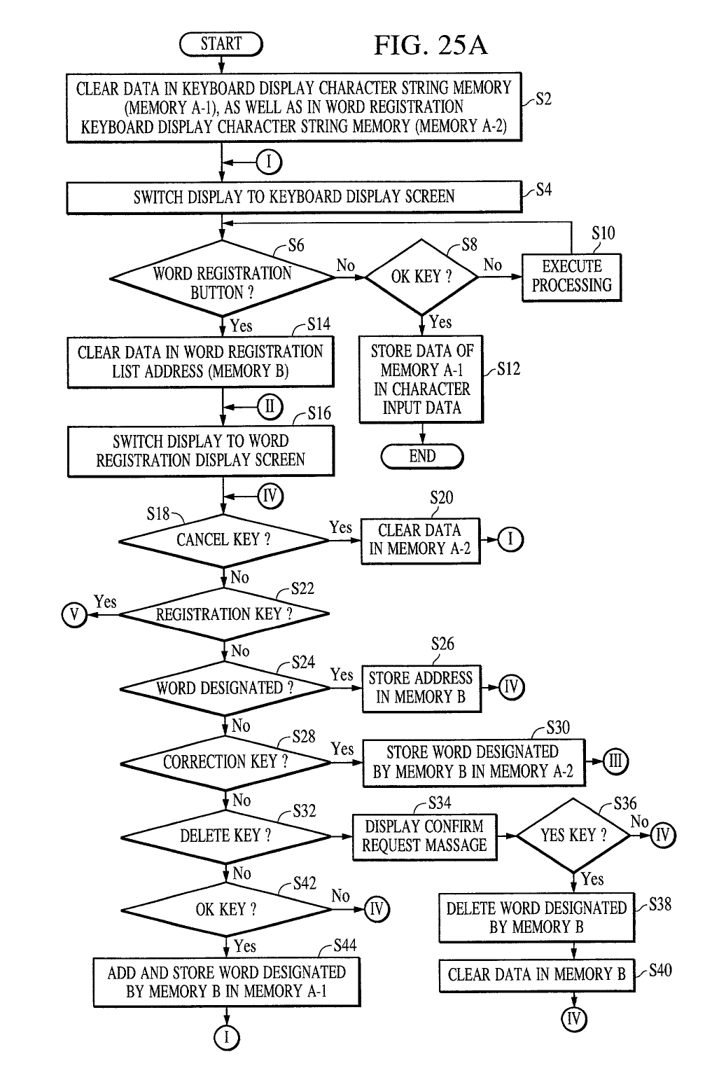

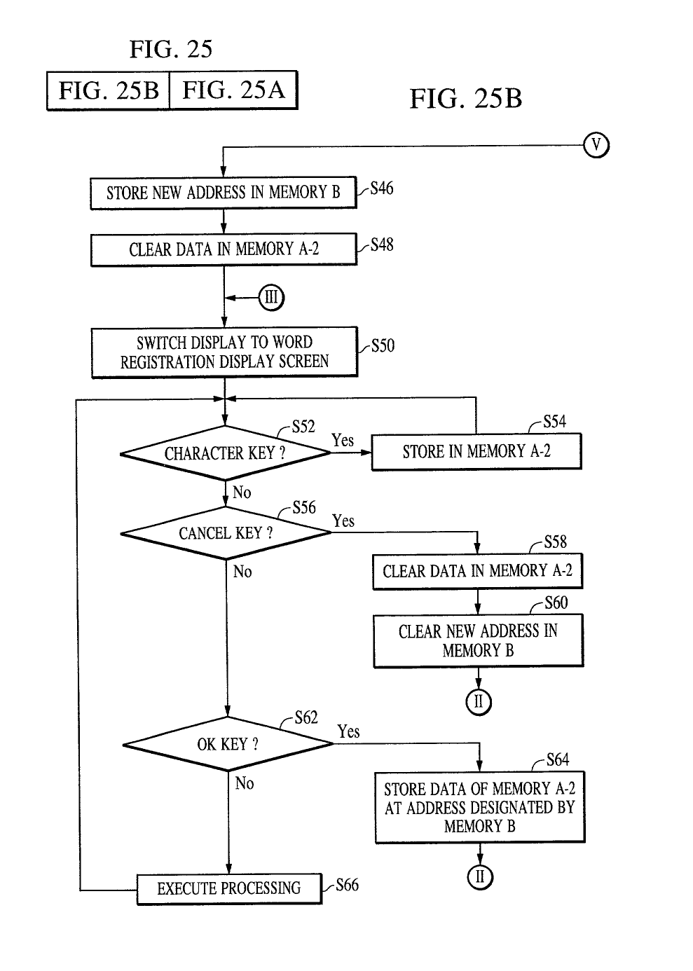

The process for controlling the transition of the display screen will be described with reference to a flowchart shown in FIG. 25. The process shown by this flowchart starts at a timing at which the mode for inputting character strings is triggered by pressing of buttons such as the subject input instruction button 91, the message input instruction button 93, the reply destination input instruction button 95 and so on. The process proceeds under the control of the CPU 2001 in accordance with the programs stored in the RAM 2002 and the ROM 2003.

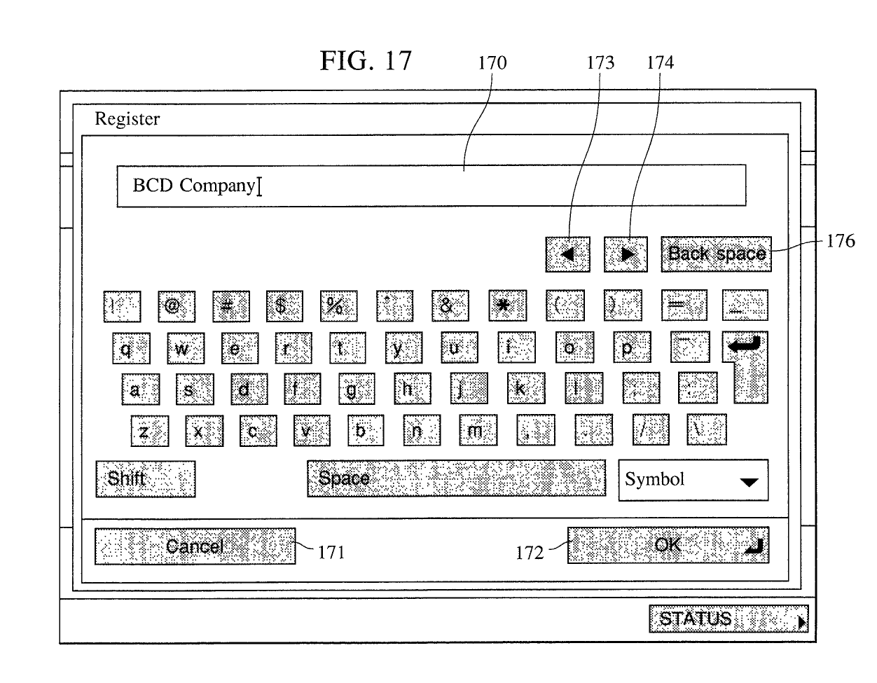

Step S2 clears the data in the keyboard display character string memory, i.e., the memory A-1 mentioned before, and the data in the word registration keyboard display character string memory, i.e., the memory A-2 mentioned before. The memories A-1 and A-2 are data storage areas preserved in the RAM 2002 and are intended to store character code strings corresponding to character string data to be displayed in character string display boxes in the keyboard display screen, e.g., the display screen shown in FIG. 13, and the word registration keyboard display screen, e.g., the display screen shown in FIG. 17. For instance, the character strings stored in the memories A-1 and A-2 are intended to fill the character string display boxes such as a box 130 shown on the display screen shown in FIG. 13 and a box 170 on the display screen shown in FIG. 17. Thus, Step S2 clears all these data to initialize the memories, by erasing the data or by setting a “data invalid” flag.

Step S4 switches the display on the operating section 2013 to the keyboard display screen of FIG. 13. The CPU then determines in Step S6 whether a word registration button 131 has been pressed. When the word registration button 131 has not been pressed, the process advances to Step S8 which determines whether an “OK” key 132 has been pressed. If the “OK” button has not been pressed, the process advances to Step S10, which executes a processing corresponding to a button pressed by the user. For instance, when a character key is pressed by the user, the character corresponding to the pressed key is stored in the memory A-1 and is displayed in the character input box 130. If the key pressed by the user is a cursor key, the cursor is moved within the character input box 130 in accordance with the instruction given by the user.

If Step S8 has determined that the “OK” key 132 has been pressed, the data stored in the memory A-1 is stored in the character input area of the RAM 2002 corresponding to the button, e.g., the subject, message or reply-to, which was selected before the instant keyboard display screen was put on the display. At the same time, the display screen is reset.

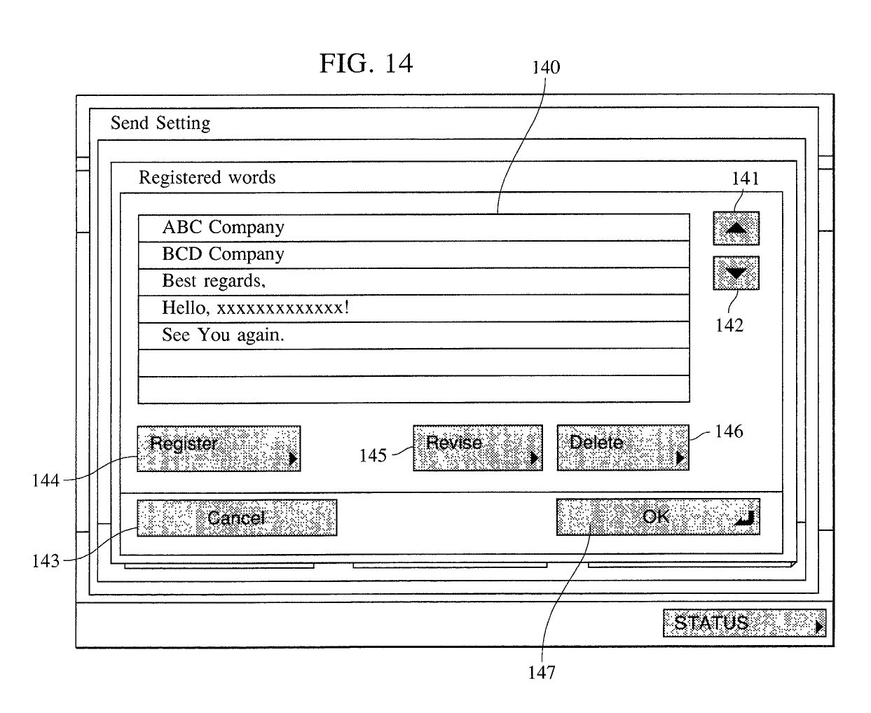

If Step S6 has determined that the word registration button 131 has been pressed, the process advances to Step S14, which clears the data in the word registration list address memory, i.e., the aforesaid memory B. This memory B is a data storage area preserved in the RAM 2002 and stores addresses of the words in the word registration list which also is stored in the RAM 2002, in order to enable identification of each of the registered words. For instance, when a desired word is designated on the registered word list display screen, e.g., the display screen of FIG. 14, the address of the designated word is stored in the memory B so that the information concerning the word is held.

Step S16 switches the display on the operating section 2013 to the word registration list display screen of FIG. 14. This display screen displays the registered word list 140 stored in the RAM. The user can select one of the registered words in the list by touching the word. The registered word list on the display can be scrolled by means of scroll keys 141 and 142.

Step S18 determines whether a cancel key 143 has been pressed. If the cancel key 143 has been pressed, the process advances to Step S20, which clears the data in the memory A-2. The process then returns to Step S4.

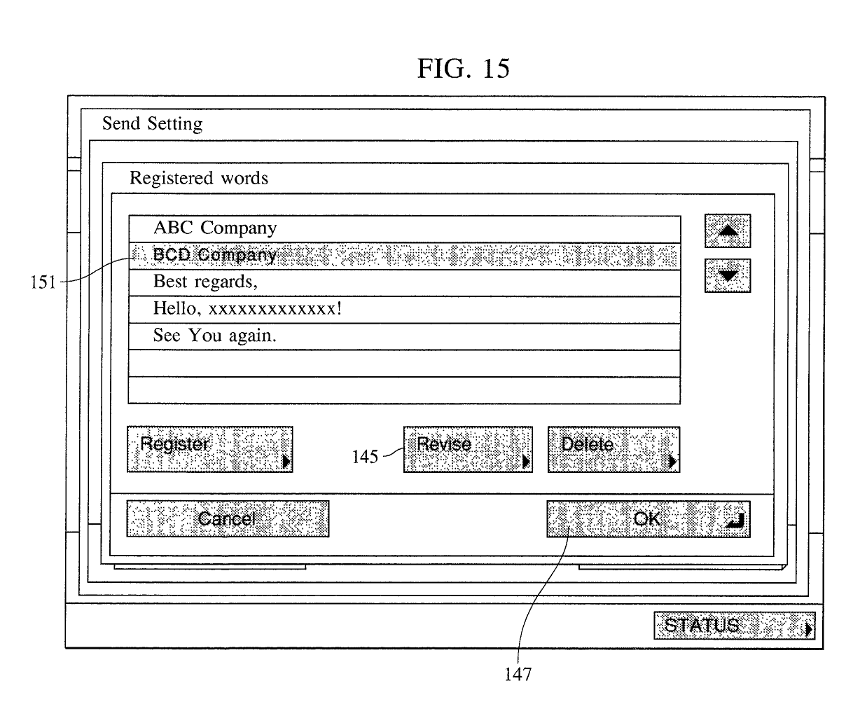

Step S22 determines whether a registration key 144 has been pressed. If the registration key 144 has not been pressed, the process advances to Step S24, which determines whether a word has been designated by the user through a touch on the registered word list. If the answer is yes, the process proceeds to Step S26, in which the designated word is stored in the memory B. The process then returns to Step S18. The state of the display is changed such that the designated word is shown by halftone so as to be distinguished from other words, as denoted by 151 in the display screen shown in FIG. 15.

Step S28 determines whether a correction key 145 has been pressed. If the correction key 145 has been pressed, the process advances to Step S30, in which the character string constituting the word identified by the address stored in the memory B is stored in the memory A. The process then advances to Step S50. It is to be noted that, when Step S24 has determined that no word has been designated, i.e., when no address is stored in the memory B, the display is made so as to reject pressing of the correction key 145.

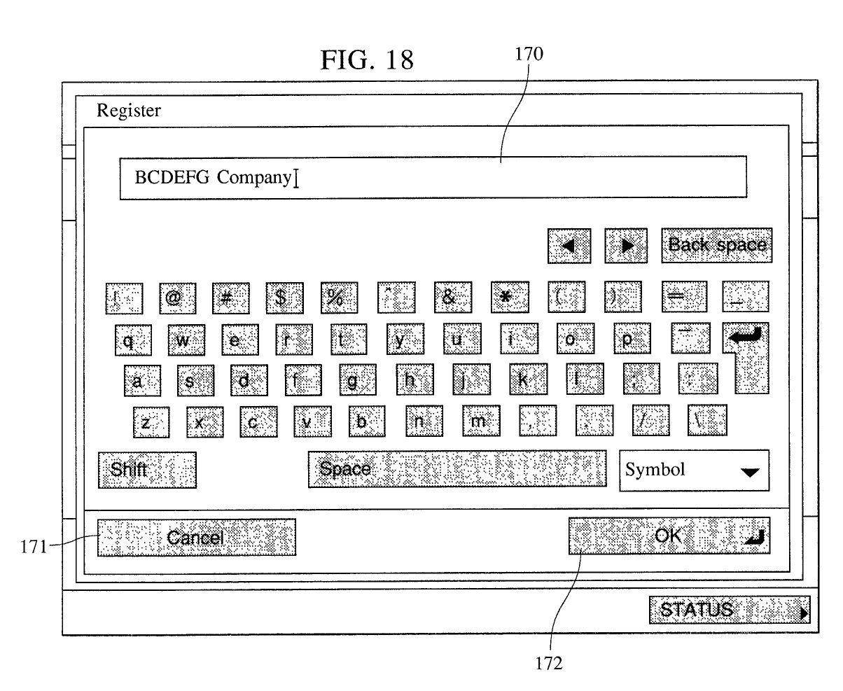

Step S50, which is executed when the correction key 145 has been pressed, switches the display on the operating section 2013 to the word registration keyboard display screen in which the character string that has been designated is displayed in the character string display box 170 of the word registration keyboard display screen, as shown in FIG. 17. In this state, the user can effect a correction on the displayed character string, by pressing a character key or keys. Thus, Step S52 determines whether a character key or keys have been pressed. If the answer is YES, the process proceeds to Step S54, in which the character or character string corresponding to the pressed key or keys is additionally stored in the memory A-2 and additionally displayed in the character string display box 170, as shown in FIG. 18. The content of the correction processing is not limited to the addition of characters. Namely, edition by combination of deletion and addition is possible by a combined use of the cursor keys 173, 174 and a back space key 176 which also has a function to delete an immediately preceding character.

If Step S52 has determined that no character key has been pressed, the process advances to Step S56 which determines whether the cancel key 171 has been pressed. If the cancel key 171 has been pressed, the correction processing is terminated and Step S58 is executed to clear data in the memory A-2. The process then returns to Step S16 via Step S60. Step S60, clears the data in the memory B only when the data is a new address. Therefore, the data in the memory B is not cleared in this case because the processing which is being executed is a correction processing. Step S16 displays the same content as that displayed prior to the pressing of the correction key 145. Namely, the selected word 151 is displayed in a manner which provides clear distinction between this word and other words.

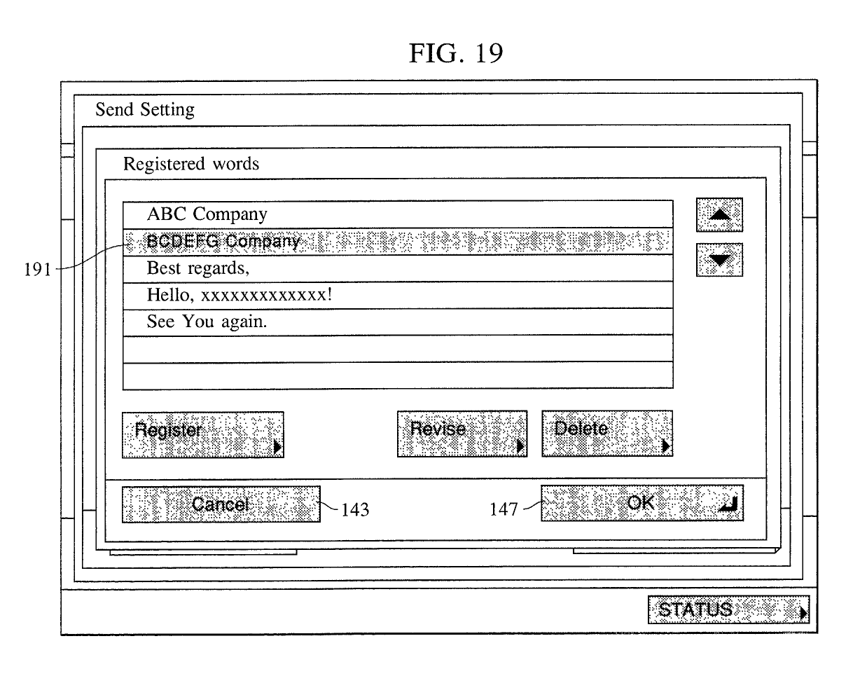

If the step S56 mentioned above has determined that the cancel key 171 has not been pressed, the process proceeds to Step S62, which determines whether the “OK” key 172 has been pressed. If the “OK” key has been pressed on the word registration keyboard in the word correction processing, the process proceeds to Step S64, in which the character string data stored in the memory A-2 is stored in the word storage area in the registered word list that is identified by the address stored in the memory B. The process then returns to Step S16. In this state, the designated word in the registered word list has been corrected, so that the corrected word 191 is displayed in the registered word list display screen, as shown in FIG. 19. It is to be noted that, after the storage of the character string in the registered word list on the RAM 2002 performed in Step S64, the registered word list in the HDD 2004 also is corrected and stored correspondingly.

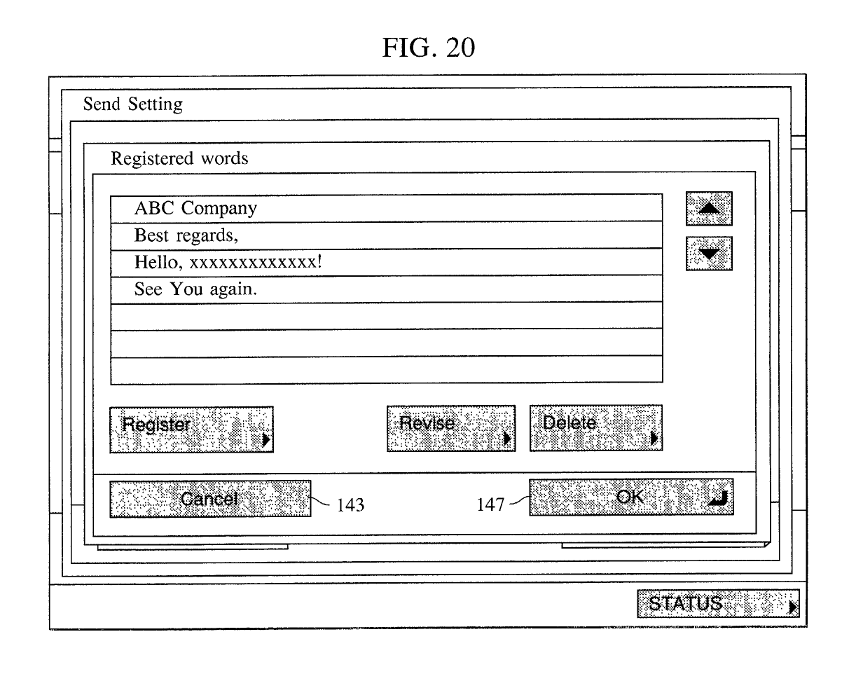

When Step S28, mentioned before, has determined that the correction key 145 has not been pressed, the process advances to Step S32, which determines whether a delete key 146 has been pressed. Upon confirming that the delete key has been pressed, the process advances to Step S34, which displays a message which requests confirmation as to whether the deletion may be performed. The user reading the message presses an “Yes” key (not shown) if the user is willing to delete the word. Step S36 determines whether the “Yes” key has been pressed. If the “Yes” key has been pressed, the process advances to Step S38, which deletes, from the registered word list in the RAM 2002, the word that is identified by the address stored in the memory B. The process then proceeds to Step S40, which clears the data in the memory B, and then returns to Step S18. Consequently, only words except for the deleted word are shown in the registered word list on the word registration display screen, as will be seen from FIG. 20. It is to be understood that, after the deletion of the character string data from the registered word list on the RAM 2002, the same character string data, i.e., the word, is deleted also from the registered word list in the HDD 2002. If the step S24 mentioned before has determined that no word has been designated, i.e., if no address has been stored in the memory B, pressing of the delete key 146 is not accepted. If pressing of the “Yes” key is not confirmed in Step S36, the delete processing is terminated and the process returns to Step S18.

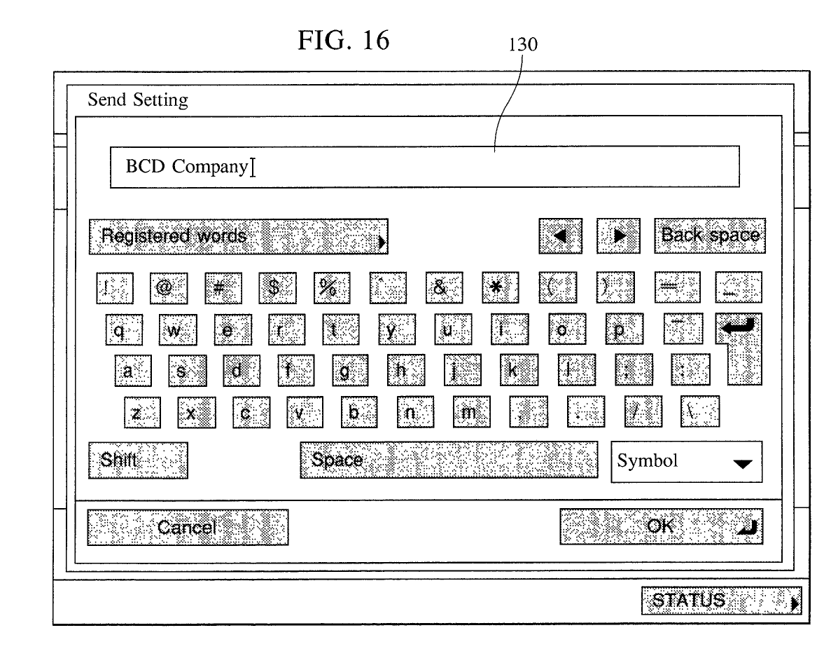

If Step S32 has determined that the delete key has not been pressed, the process advances to Step S42, which determines whether the “OK” key 147 has been pressed. If the “OK” key has been pressed, the process advances to Step S44, in which the character string identified by the address stored in the memory B is additionally stored in the memory A-1. The process then returns to Step S4. It is to be noted that the additional storage of the character string identified by the address stored in the memory B in the memory A-1 is performed such that the character string is inserted into the character string in the display box 130 on the keyboard display screen, at the position designated by the cursor. For instance, in the example shown in FIG. 15, the character string codes corresponding to “BCD Company” is stored in the memory A-1 and the words “BCD Company” are displayed in the character string display box 130 of the keyboard display screen as shown in FIG. 16, because the “OK” key 147 was pressed while the second character strings reading “BCD Company” had been selected. If a certain character string has already been displayed in the character string display box 130, with the cursor pointing a position between two adjacent characters, the character string of the word identified by the address stored in the memory B is inserted at the position between these two characters pointed by the cursor.

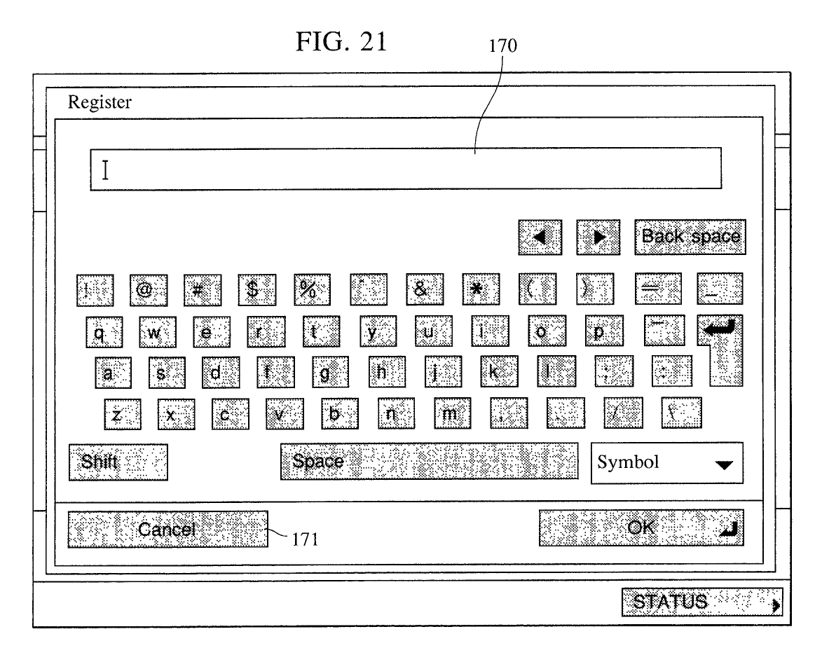

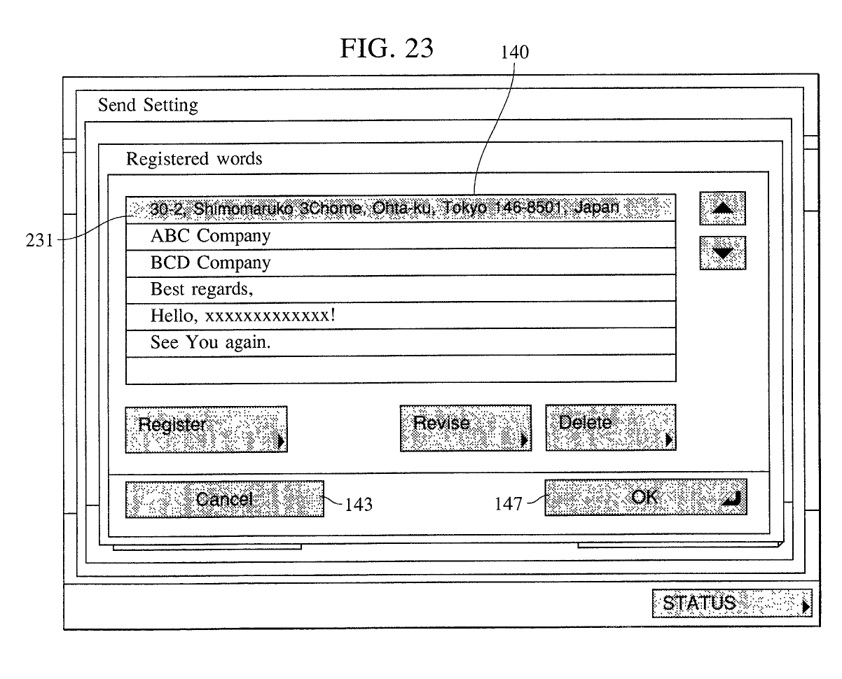

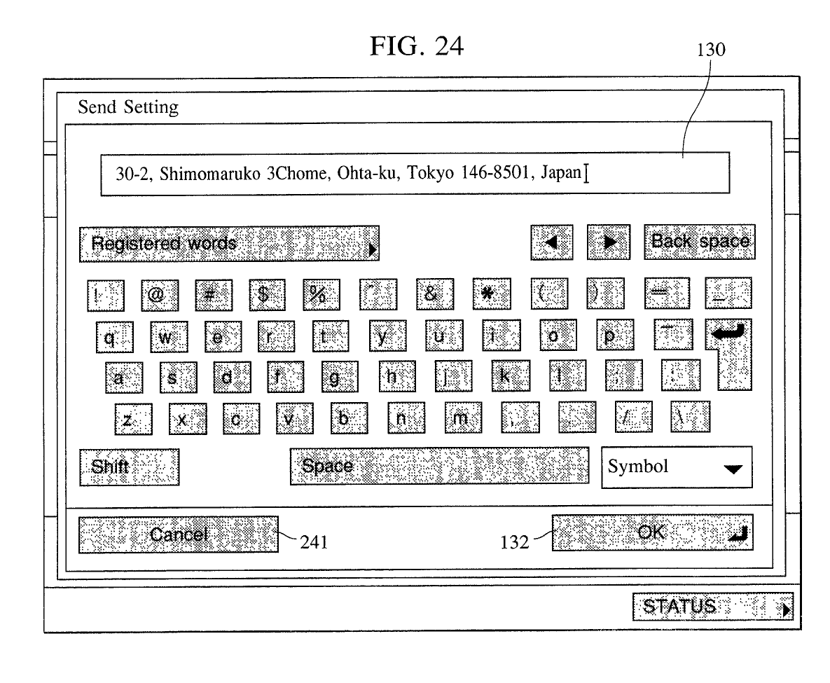

Referring back to Step S22, when this step has determined that the registration key 144 has been pressed, the process advances to Step S46, in which a new address is stored in the memory B. Thus, a processing for registering a new word to the registered word list is triggered by the pressing of the-registration key 144. The “new address” to be registered in the memory B in Step S46 is the address of a new area in the registered word list on the RAM 2002, i.e., an area which is vacant and ready to store the new word. The process then advances to Step S48, which clears the data in the memory A-2, and then to Step S50, which switches the display on the operating section 2013 to the word registration display screen. The word registration display screen presented in Step S50 is shown in FIG. 21. The process then advances to Step S52, which determines whether a character key has been pressed. If a character key has been pressed, the character code corresponding to the pressed key is stored in the memory A-2 in Step S54, whereby the input character string 221 is displayed in the character string display box 170. If Step S52 has determined that no character key has been pressed, the process advances to Step S56, which determines whether the cancel key 171 has been pressed. If the cancel key 171 has been pressed, the process advances to Step S58, which clears the data in the memory A-2. The process then returns to Step S16 (see FIG. 14), after executing Step S60, which clears the new address in the memory B. If Step S56 has determined that the cancel key 171 has not been pressed, the process proceeds to Step S62, which determines whether the “OK” key 172 has been pressed on the word registration keyboard display screen. If the “OK” key-172 has been pressed, Step S64 is executed, in which the data held in the memory A-2 is stored in the word storage area in the registered word list on the RAM 2002 identified by the address stored in the memory B. The process then returns to Step S16. It is to be noted that, after the storage of the character string data in the registered word list on the RAM 2002 performed in Step S64, the same character string data is stored also in the registered word list in the HDD 2004. After the registration of the new word, the newly registered character string 231 is displayed on the registered word list display screen, in a manner which indicates that the character string 231 has been selected, as shown in FIG. 23. When the “OK” key 147 is pressed on this registered word list display screen, Step S42 confirms the pressing so that the process advances to Step S44, in which the selected word, i.e., the word identified by the address stored in the memory B, is additionally stored in the memory A-1, whereby the word is displayed in the character string display box 130 of the keyboard display screen, as shown in FIG. 24.

In the embodiment described heretofore, the content of the display on the operating section 2013 are changed over the keyboard display screen, the registered word list display screen and the word registration display screen, such that one of these display screens is shown at a time. This, however, is only illustrative and the arrangement may be such that a display screen which is to be shown next is shown in a portion of the display screen which is presented on the operating section 2013. It is also possible to arrange such that the display screen to be shown next to the display screen which is now on display is shown in another display device.

Different users may have different registered word lists. In such a case, the arrangement may be such that the registered word list of each user is selected and displayed when the user is identified. To this end, an ID code for identifying the user is added to the registered word list when the list is stored, so that the registered word list can be selected and displayed each time a user ID code is input. The user ID code which is input when the user commences the use of the image processing apparatus may be used for the purpose of selecting the registered word list.

As will be understood from the foregoing description, the illustrated embodiment shows, in the form of an at-a-glance list, a plurality of registered character strings, so as to allow the user to select one of the character strings. The selected character string is automatically displayed on the display screen at a position pointed by a cursor. This relieves the user from the burden of pressing one by one the character keys of character strings constituting words that are used by the user frequently, thus contributing to improvements both in the efficiency of work and operability of the keyboard display screen.

In the illustrated embodiment, the character string of interest can simply be selected by pointing a position in the region where the character string is displayed. This permits an easy and accurate selection of the character string of interest from among a plurality of character strings.

The above-mentioned at-a-glance list of character strings is presented by means of a soft keyboard. It is therefore possible to easily perform an operation for inputting a character string in any situation in which the soft keyboard is displayed for the entry of characters.

The list of the character strings can easily be put on the display whenever the user gives an instruction on the soft keyboard display screen requesting the display of the character string list.

In response to the above-mentioned instruction given through the soft keyboard display screen, the display is switched from the soft keyboard display screen to the display screen which shows the at-a-glance list of the character strings. This permits an efficient use of the limited area of the display screen.

The above-mentioned plurality of character strings may have been prepared by each user, such that the character strings to be used by each user are automatically presented on the display in the form of at-a-glance list.

When the display screen for entering a character string to be added to image information is on the display, the character string is selected efficiently in the manner described above, whereby the addition of the words to an image can be performed easily.

Further, when the display screen for entering a character string to be added to image information is on the display, entry of the character string to be added can be achieved easily by virtue of the at-a-glance display of a plurality of registered character strings.

W, the character string, is selected efficiently in the manner described above, whereby the designation of the destination can be performed easily.

Further, when the display screen is on the display to enable the user to enter a character string that designates a destination to which information is to be sent, entry of the character string designating the destination can be achieved easily by virtue of the at-a-glance display of a plurality of registered character strings.

The image processing apparatus may be a copying machine. In such a case, the at-a-glance list of a plurality of registered character strings may be displayed on an operation panel of the copying machine, so as to greatly facilitate entry of character strings to be used in the operation of the copying machine.

Further, in the described embodiment, the character string that has been efficiently selected in the described manner can be output by means of a printer, such as an ink jet printer or a laser-beam-type printer, whereby the character string efficiently entered can be printed with a high printing quality.

The user can input an instruction through a touch panel, which provides a user-friendly operation environment.

The user also can input an instruction by means of a digitizer, which does not require any skill or experience to operate.

The user also can input an instruction my means of a coordinate input device, which permits easy entry of complicated information.

The described embodiment displays at-a-glance list of a plurality of registered character strings for the selection by the user. The user can select one of the character strings and give an instruction for a specific editorial work to be effected on the selected character string. The selected character string is processed in accordance with the editorial instruction. The list of the registered character strings is therefore updated in accordance with the result of the editorial work. It is therefore possible to alter as desired the state of registration of the character strings that are intended to facilitate entry of words and the like, so as to provide a working environment that best suits each user, thus achieving a further improvement in the efficiency of operation.

The above-mentioned editorial instruction may be an instruction for adding characters. In such a case, a desired character string can easily be formed and registered by making use of the character strings that have already been registered.

The above-mentioned editorial instruction may be an instruction for deleting characters. In such a case, a group of characters devoid of unnecessary character strings can be displayed to facilitate detection of the character string of interest, while saving memory area.

A soft keyboard display screen may be used to enable the user to give the editorial instructions, thus providing a working environment which facilitates various kinds of editorial work to be executed by the user.

Although the invention has been described with reference to its preferred forms, it is to be understood that the described embodiment is only illustrative, and various changes and modifications may be imparted thereto without departing from the scope of the present invention, which is limited solely by the appended claims.

What is claimed is:

1. A character processing method, comprising the steps of:
performing at-a-glance display of a plurality of registered character strings;
allowing a character string to be selected from among the displayed character strings; and
causing the selected character string to be displayed at a position pointed by a cursor.

2. A character processing method according to claim 1, wherein the selection of the character string is achieved by an instruction which designates a position in a region in which the character string to be selected is displayed.

3. A character processing method according to claim 1, wherein the at-a-glance display of the character strings is performed on a soft keyboard display screen.

4. A character processing method according to claim 1, wherein the at-a-glance display of the character strings is performed in accordance with an instruction given through a soft keyboard display screen.

5. A character processing method according to claim 4, wherein the at-a-glance display of the character strings is displayed in place of the soft keyboard display screen, in response to said instruction.

6. A character processing method according to claim 1, wherein said plurality of character strings have been registered through an operation performed by the user.

7. A character processing method according to claim 1, wherein the selected character string is input to a display screen which is displayed to enable entry of a character string to be added to image information.

8. A character processing method according to claim 1, wherein the at-a-glance display of the registered character strings is performed on a display screen which is displayed to enable entry of a character string to be added to image information.

9. A character processing method according to claim 1, wherein the selected character string is input to a display screen which is displayed to enable entry of a character string designating a destination to which information is to be sent.

10. A character processing method according to claim 1, wherein the at-a-glance display of the registered character strings is performed on a display screen which is displayed to enable entry of a character string designating a destination to which information is to be sent.

11. A character processing method according to claim 1, wherein the at-a-glance display of the registered character strings is implemented on an operation panel of a copying machine.

12. A character processing method according to claim 1, wherein the selected character string is output by means of a printer.

13. A character processing method according to claim 2, wherein said instruction is given through a touch panel.

14. A character processing method according to claim 2, wherein said instruction is given through a digitizer.

15. A character processing method according to claim 2, wherein said instruction is given through a coordinate input device.

16. A character processing method, comprising the steps of:
performing an at-a-glance display of a plurality of registered character strings;
allowing selection of a desired character string from among the displayed character strings;
receiving an editorial instruction indicating an editorial work to be effected on the selected character string;
effecting the editorial work in accordance with the editorial instruction on the selected character string; and
updating the registered character strings in accordance with the result of the editorial work.

17. A character processing method according to claim 16, wherein said editorial instruction is to add a character.

18. A character processing method according to claim 16, wherein said editorial instruction is to delete a character.

19. A character processing method according to claim 16, wherein said editorial instruction is input through a displayed soft keyboard.

20. A character processing apparatus, comprising:
at-a-glance displaying means for performing at-a-glance display of a plurality of registered character strings;
selecting means for enabling a character string to be selected from among the displayed character strings; and
displaying-means for displaying the selected character string at a position pointed by a cursor.

21. A character processing apparatus according to claim 20, wherein said selecting means selects the character string in accordance with an instruction which designates a position in a region in which the character string to be selected is displayed.

22. A character processing apparatus according to claim 20, wherein said at-a-glance displaying means comprises means for displaying a soft keyboard display screen.

23. A character processing apparatus according to claim 20, wherein the at-a-glance display of the character strings is performed in accordance with an instruction given through a soft keyboard display screen.

24. A character processing apparatus according to claim 23, wherein the at-a-glance display of the character strings is displayed in place of the soft keyboard display screen, in response to said instruction.

25. A character processing apparatus according to claim 20, wherein said plurality of character strings have been registered through an operation performed by the user.

26. A character processing apparatus according to claim 20, wherein the selected character string is input to a display screen which is displayed to enable entry of a character string to be added to image information.

27. A character processing apparatus according to claim 20, wherein said at-a-glance displaying means displays on a display screen to enable entry of a character string to be added to image information.

28. A character processing apparatus according to claim 20, wherein the selected character string is input to a display screen which is displayed to enable entry of a character string designating a destination to which information is to be sent.

29. A character processing apparatus according to claim 20, wherein said at-a-glance displaying means displays a display screen to enable entry of a character string designating a destination to which information is to be sent.

30. A character processing apparatus according to claim 20, wherein said at-a-glance displaying means comprises an operation panel of a copying machine.

31. A character processing apparatus according to claim 20, further comprising a printer for outputting the selected character string.

32. A character processing apparatus according to claim 21, further comprising a touch panel through which said instruction is given.

33. A character processing apparatus according to claim 21, further comprising a digitizer through which said instruction is given.

34. A character processing apparatus according to claim 21, further comprising a coordinate input device through which said instruction is given.

35. A character processing apparatus, comprising:
at-a-glance displaying means for performing an at-a-glance display of a plurality of registered character strings;
selecting means for allowing selection of a desired character string from among the displayed character strings;
inputting means for enabling input of an editorial instruction indicating an editorial work to be effected on the selected character string;
editing means for effecting the editorial work in accordance with the editorial instruction on the selected character string; and
updating means for updating the registered character strings in accordance with the result of the editorial work.

36. A character processing apparatus according to claim 35, wherein said editorial instruction is to add a character.

37. A character processing apparatus according to claim 35, wherein said editorial instruction is to delete a character.

38. A character processing apparatus according to claim 35, wherein said at-a-glance displaying means further comprises a soft keyboard displaying means for displaying a soft keyboard as a display screen through which said editorial instruction is input.

39. A character processing apparatus according to claim 35, wherein the update performed by said updating means includes addition of a character string.

40. A character processing apparatus according to claim 35, wherein the update performed by said updating means includes deletion of a character string.

41. A computer-readable storage medium which stores:
program codes for performing at-a-glance display of a plurality of registered character strings;
program codes for allowing a character string to be selected from among the displayed character strings; and
program codes for causing the selected character string to be displayed at a position pointed by a cursor.

42. A computer-readable storage medium which stores:
program codes for performing an at-a-glance display of a plurality of registered character strings;
program codes for allowing selection of a desired character string out of the displayed character strings;
program codes for receiving an editorial instruction indicating an editorial operation to be effected on the selected character string;
program codes for effecting the editorial operation in accordance with the editorial instruction on the selected character string; and
program codes for updating the registered character strings in accordance with the result of the editorial operation.
